(19) United States
(12) Patent Application Publication
(10) Pub. No.: US 2014/0215433 A1
(43) Pub. Date: Jul. 31, 2014

(54) CLASS ORIENTED FILE FORMAT FOR MODELING AND PERSISTING BPMN SCRIPTING CODE

(71) Applicant: ORACLE INTERNATIONAL CORPORATION, Redwood Shores, CA (US)

(72) Inventors: Ezequiel Mauro Bergamaschi, Buenos Aires (AR); Ariel Morelli Andres, Buenos Aires (AR); Paulo Gustavo Veiga, Buenos Aires (AR); Gustavo Battistoni, Buenos Aires (AR)

(73) Assignee: ORACLE INTERNATIONAL CORPORATION, Redwood Shores, CA (US)

(21) Appl. No.: 14/168,989

(22) Filed: Jan. 30, 2014

Related U.S. Application Data
(60) Provisional application No. 61/758,729, filed on Jan. 30, 2013.

(51) Int. Cl. G06F 9/44

(52) U.S. Cl. CPC G06F 8/31
USPC 717/106

(57) ABSTRACT

A computer-implemented method can include generating Business Process Modeling Notation (BPMN) scripts for one or more BPMN processes, and storing each BPMN script in a class oriented format in a file that is separate from the corresponding BPMN process.

### CROSS-REFERENCE TO RELATED APPLICATION

This application claims the benefit of U.S. Provisional Patent Application Ser. No. 61/758,729, titled “CLASS ORIENTED FILE FORMAT FOR MODELING AND PERSISTING BPMN SCRIPTING CODE” and filed on Jan. 30, 2013, the content of which is fully incorporated by reference herein.

### BACKGROUND

The business world has changed dramatically over the last few years and processes can now involve multiple participants and, as a result, coordination thereof is often very complex. The Business Process Modeling Notation (BPMN) 2.0 standard specifies that processes can contain “script tasks” to enable users to include scripts in their processes. However, the standard does not mandate any format to persist such script. Thus, several vendors have included the script inside the BPMN process, but this has a number of disadvantages. For example, the resulting file is generally difficult to read for people that do not understand both business and technical concepts and, if such is not the case, the person will usually only be able to understand a portion of the file. This raises a number of issues in collaborative editing environments, especially when using version control systems, where the users are supposed to resolve conflicts between their changes and other persons' changes. Another disadvantage is that, in certain cases, the scripting characters need to be escaped to be included inside the Extensible Markup Language (XML) structure of the BPMN process, which renders the script unreadable by humans.

Thus, there remains a need for a way to address these and other problems associated with the prior art.

### BRIEF DESCRIPTION OF THE DRAWINGS

FIG. 1 illustrates an example of a networked system in accordance with certain embodiments of the disclosed technology.

FIG. 2 illustrates an example of an electronic device in which certain aspects of various embodiments of the disclosed technology may be implemented.

FIG. 3 is a flowchart illustrating a first example of a computer-controlled method in accordance with certain embodiments of the disclosed technology.

### DETAILED DESCRIPTION

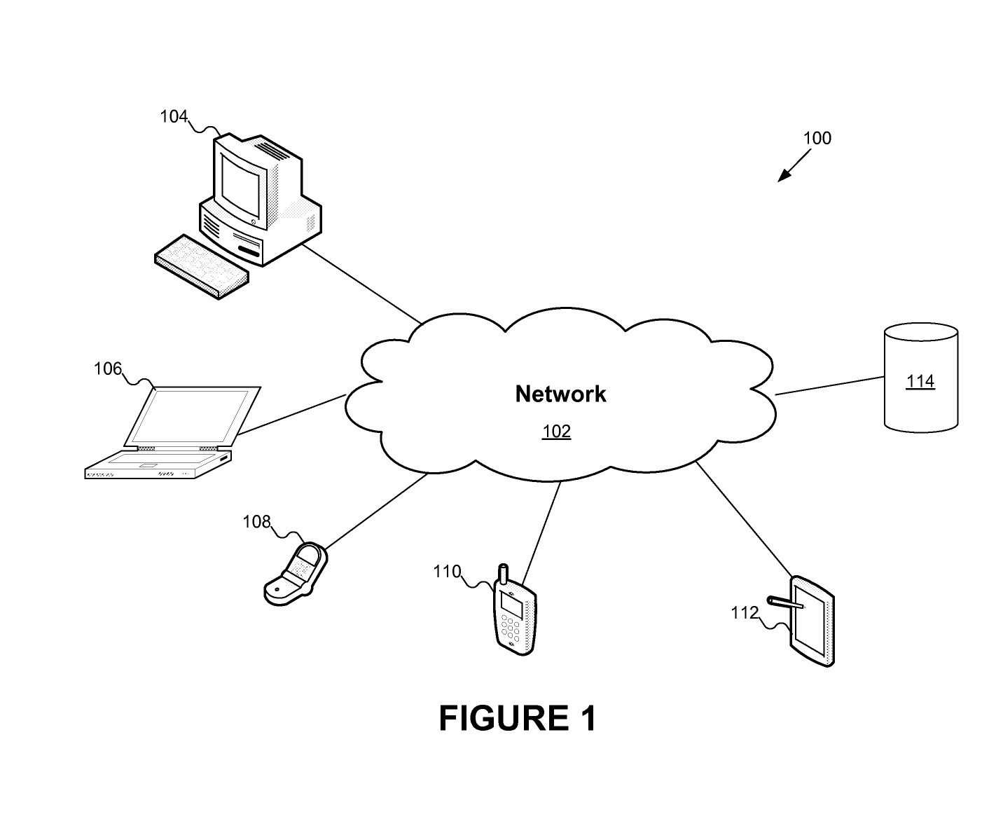

FIG. 1 illustrates an example of a networked system 100 in accordance with certain embodiments of the disclosed technology. In the example, the system 100 includes a network 102 such as the Internet, an intranet, a home network, a public network, or any other network suitable for implementing embodiments of the disclosed technology. In the example, personal computers 104 and 106 may connect to the network 102 to communicate with each other or with other devices connected to the network.

The system 100 also includes three mobile electronic devices 108-112. Two of the mobile electronic devices 108 and 110 are communications devices such as cellular telephones or smartphones. Another of the mobile devices 112 is a handheld computing device such as a personal digital assistant (PDA), tablet device, or other portable device. A storage device 114 may store some of all of the data that is accessed or otherwise used by any or all of the computers 104 and 106 and mobile electronic devices 108-112. The storage device 114 may be local or remote with regard to any or all of the computers 104 and 106 and mobile electronic devices 108-112.

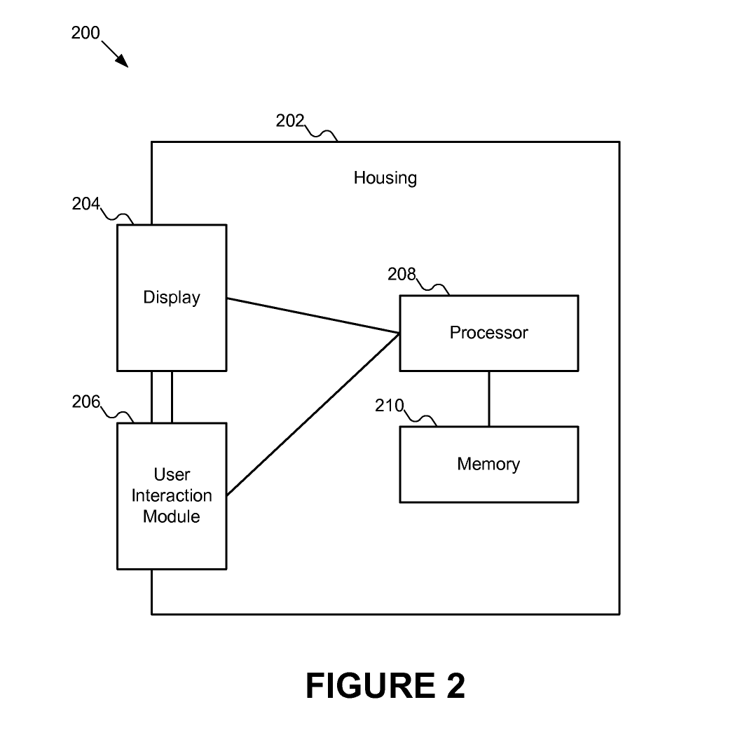

FIG. 2 illustrates an example of an electronic device 200, such as the devices 104-112 of the networked system 100 of FIG. 1, in which certain aspects of various embodiments of the disclosed technology may be implemented. The electronic device 200 may include, but is not limited to, a personal computing device such as a desktop or laptop computer, a mobile electronic device such as a PDA or tablet computing device, a mobile communications device such as a smartphone, an industry-specific machine such as a self-service kiosk or automated teller machine (ATM), or any other electronic device suitable for use in connection with certain embodiments of the disclosed technology.

In the example, the electronic device 200 includes a housing 202, a display 204 in association with the housing 202, a user interaction module 206 in association with the housing 202, a processor 208, and a memory 210. The user interaction module 206 may include a physical device, such as a keyboard, mouse, microphone, speaker, touchscreen or touchpad, or any combination thereof, or a virtual device, such as a virtual keypad implemented within a touchscreen. The processor 208 may perform any of a number of various operations. The memory 210 may store information used by or resulting from processing performed by the processor 208.

Business Process Modeling Notation (BPMN) refers to a graphic notation that generally describes the logic of multiple steps in a given business process and may be used to coordinate the sequence of processes and messages that flow between participants of various activities. BPMN generally enables the modeling, simulation, and execution of business processes.

Embodiments of the disclosed technology generally pertain to storing BPMN scripts and processes in different files and formats. While the processes are generally persisted in BPMN 2.0, which is a well-known format for business analysts and others, the scripts are generally persisted using an intuitive format for developers.

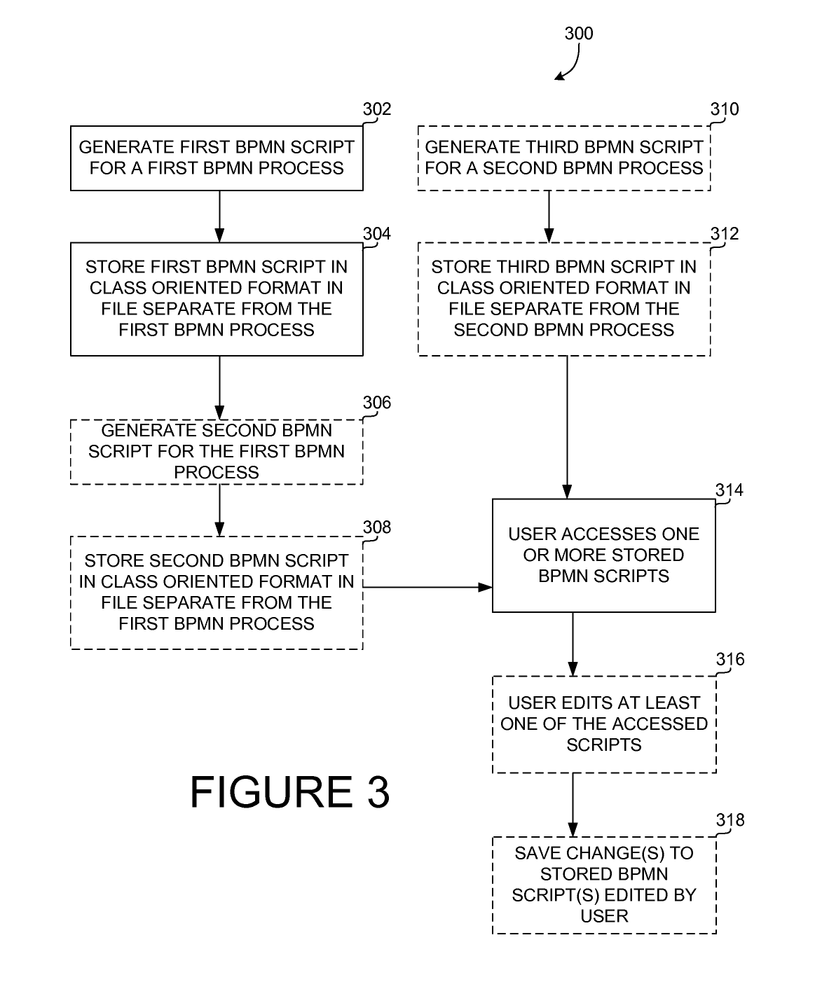

FIG. 3 is a flowchart illustrating a first example of a computer-controlled method 300 in accordance with certain embodiments of the disclosed technology. At 302, a first BPMN script is generated for a first BPMN process. The first BPMN script may be generated in accordance with any appropriate BPMN script-generating technique. At 304, the first BPMN script is stored as a class oriented format in a file that is separate from the first BPMN process.

In certain embodiments, there may be multiple BPMN scripts for a given BPMN process. The optional steps at 306 and 308 illustrate such a situation. At 306, a second BPMN script is generated for the first BPMN process. At 308, the second BPMN script is stored as a class oriented format in a file that is separate from the first BPMN process. The second BPMN script may be stored in the same file as the first BPMN script, in a separate file, or both.

In certain embodiments, there may be at least one BPMN script for each of multiple BPMN processes. The optional steps at 310 and 312 illustrate such a situation. At 310, a third BPMN script is generated, the first for a second BPMN process. At 312, the third BPMN script is stored as a class oriented format in a file that is separate from the second BPMN process. The third BPMN script may be stored in the same file as either (or both) of the first and second BPMN scripts, in a separate file, or both.

At 314, a user may access a stored BPMN script, e.g., any or all of the first, second, and third BPMN scripts. At 316, the user may edit any or all of the scripts he or she accessed at 314. Once the user has finished his or her edits to the script(s), the revised script(s) may be stored, as indicated at 316. This may be accomplished by revising the actual stored file(s) or creating new file(s) while maintaining the original file(s), for example.

Storing scripts as a class oriented format in a different file from the process will generally improve the readability of process and scripts because business analysts and others will not need to deal with script structures while script developers will intuitively understand the script file structure and its associated runtime behavior. As each script is stored in a class format, the existing tools for comparing differences and merging conflicts of source files may also be used with the script file. As the persistence of scripts is done in a different file from the BPMN process, there will generally be no conflicts between information technology (IT) developer and business analyst changes in collaborative editing environments, e.g., using version control systems.

Certain embodiments of the disclosed technology include a mapping between BPMN artifacts and object-oriented programming language artifacts. Such a mapping may be in the semantic, conceptual, and runtime behavior perspective as well as from the point of view of the persistence. An example of such a mapping includes the following:
Whereas a BPMN process generally defines the flow that tokens will transverse, a class generally defines the structure that instances will have in object-oriented programming languages.
In BPMN, a token is a theoretical concept that transverses the process through the sequence flow. Tokens generally have a life cycle associated therewith, e.g., they are created in a Start Event and later consumed by an End Event. This may be represented as an instance of the process/subprocess class, which has the same life cycle as the token.
A data object (e.g., a BPMN artifact) may be mapped to a class field (e.g., an object-oriented language artifact). Whereas BPMN tokens generally have the state stored in data objects, the instances generally have the state in instance fields in object-oriented languages.
In BPMN, a script is typically a piece of code that is called at some point in the process to alter the state of the data objects. This may be seen as a method in the process class.
BPMN subprocesses generally have two main characteristics. The first is that such subprocesses are typically embedded in a parent process/subprocess, thus giving the idea of a static inner class. The second characteristic is that a BPMN subprocess token generally has visibility of all of its parent data objects. In object-oriented languages, this may be modeled using inheritance of the parent process/subprocess class.

Apart from the data objects, there is generally no duplicated data between the script files and process files. In order to avoid the data object duplication in both files, the data objects will typically be stored in the BPMN process file. In order to make data objects visible from the script, the fields may be injected into the class in the background. Such injection may be implemented using either on-the-fly code instrumentation or added in a compilation phase.

In order for the parser to retrieve incomplete and erroneous scripts, the beginning and the end of each script may be determined by the code indentation such that, when the script file is written, the code may be indented in a way that can be retrieved later.

In certain embodiments, Groovy is the preferred scripting language. In such embodiments, the mapping may be applied to any dynamic object-oriented programming language.

There are two main scenarios where Scripting will have an integration with a BPMN Process. The first involves Script Tasks, e.g., within the Script activity. In such situations, a complex snippet of code may be stored. The second involves Expressions, e.g., where simple Boolean or Integer expressions may be used in a BPMN Process. In such situations, the usage may be in scenarios such as Conditional Sequence Flows and Data Associations. In each case, the persistence may be managed differently.

Expressions persistence may be managed such that expressions are part of a BPMN file and not an isolated file. Script task persistence may involve a Script Task activity script being persisted in a Process Script Task file (e.g., a gy file) along with the BPMN Process. For each BPMN process, a file may be created to contain all of the scripts for the given process.

A Groovy file (.gy file) will generally model as a class method each Script Activity in the process. Storing scripts as a class format generally improves the readability of a script for developers. Also, existing tools for comparing differences and merging conflicts of source files may be used. Using an object-oriented format to store scripts may allow for the use of code debug tools in an easy way. The class may be called equal to the process name and each method may be called equal to the Script Task activity name. An example BPMN Process called SimpleProcess.gy is as follows:

```
package test.scripting.bpmn.process;
import myPackage.Person;
import myPackage.CarBO;
public class SimpleProcess {
  public void simpleTask1( ) {
    //SimpleTask1 Script Activity code
    this.myCar = new CarBO( )
  }
  public void simpleTask2( ) {
    //SimpleTask2 Script Activity code
    Person myPerson = new Person( )
    myPerson.name = ‘John’
    printIn myPerson
  }
}
```

In the example, there are two Script Task activities modeled as methods of it class, with their respective source code.

In certain Script Task persistence for BPMN Subprocess examples, Script Task Activities for a Subprocess may be persisted in the same Process Script Task file (e.g., .gy file) of the parent BPMN Process. In such embodiments, there will typically be a public static Inner Class for each BPMN Subprocess inside a BPMN Process, as illustrated by the following example:

```
package test.scripting.bpmn.process;
import myPackage.CarBO;
public class SimpleProcess2 {
  public void SimpleTask1( ) {
    //SimpleTask1 Script Activity code
    this.myCar = new CarBO( )
  }
  public static class MySubprocess extends SimpleProcess2 {
    public void SubprocessScriptTask1( ) {
      //SubprocessScriptTask1 Script Activity code
      this.subprocessDataObject = ‘this is a test’
    }
  }
}
```

The BPMN 2.0 standard defines a “Script Task” activity and a “Global Script Task” callable element that are evaluated by executing a routine written in any script language supported by the BPMN Engine. The BPMN standard does not require a specific language. A BPMN Script task generally refers to an activity that executes a code programmed by a BPMN developer. This code is typically written in Scripting Language and can access and/or modify Data Objects.

Certain embodiments of the disclosed technology include the addition of support for implementing and executing a script task, which has input and output arguments and can operate on them, e.g., to update the value of data objects. UI elements may be used to edit the scripts and detect errors before deployment; otherwise, script errors would generally be reported in runtime. A UI interface may be used to specify certain formal parameters, e.g., input and output arguments, and bind them to actual arguments.

In certain embodiments, a class may be generated for each process/subprocess. The class may contain one method for each script task in the process/subprocess. The class may have one getter and one setter for each Process Data Object that is in context. In order to make data objects visible from the script, the fields may be injected into the class behind the scenes.

Consider an example in which a process has two Script tasks (scritpTaskOne and scritpTaskTwo) with two Data Objects (myStringDataObject (String), myIntDataObject(Int)). The class for such a process may look like the following:

```
package test.scripting.bpmn.process;
public class MyProcess{
  private DataObjectAccessor engineContext
  public MyProcess(DataObjectAccessor engineContext) {
    this.engineContext = engineContext
  }
  public String getMyStringDataObject( ) {
    return engineContext.getDataObject(“myStringDataObject”)
  }
  public void setMyStringDataObject (String value) {
    engineContext.setDataObject(“myStringDataObject”, value)
  }
  public Integer getMyIntDataObject ( ) {
    return engineContext.getDataObject(“myIntDataObject”)
  }
  public void setMyIntDataObject (Integer value) {
    engineContext.setDataObject(“myIntDataObject”, value)
  }
}
```

If a Subprocess is added to the process with a new dataObject (carBODataObject (CarBO)) and a new scriptTask (subProcessScriptTask), a new class may be generated, e.g., as an inner class of the process, and may extend from it, e.g., as follows:

```
package test.scripting.bpmn.process;
public class MyProcess{
  private DataObjectAccessor engineContext
  public MyProcess(DataObjectAccessor engineContext) {
    this.engineContext = engineContext
  }
  public String getMyStringDataObject( ) {
    return engineContext.getDataObject(“myStringDataObject”)
  }
  public void setMyStringDataObject (String value) {
    engineContext.setDataObject(“myStringDataObject”, value)
  }
  public Integer getMyIntDataObject ( ) {
    return engineContext.getDataObject(“myIntDataObject”)
  }
  public void setMyIntDataObject (Integer value) {
    engineContext.setDataObject(“myIntDataObject”, value)
  }
  public static class SubProcess extends MyProcess{
    public SubProcess(DataObjectAccessor engineContext) {
      super(engineContext)
    }
    public CarBO getCarBODataObject( ) {
      return engineContext.getDataObject(“carBODataObject”)
    }
    public void setCarBODataObject(CarBO value) {
      engineContext.setDataObject(“carBODataObject”, value)
    }
    public void subProcessScriptTask( ) {
      if (myStringDataObject == null) {
        myStringDataObject = ‘this is a test’
      }
    }
  }
}
```

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

We claim:

1. A computer-implemented method, comprising:
generating a first Business Process Modeling Notation (BPMN) script for a first BPMN process; and
storing the first BPMN script in a class oriented format in a first file that is separate from the first BPMN process.

2. The computer-implemented method of claim 1, further comprising:
generating a second BPMN script for the first BPMN process; and
storing the second BPMN script in a class oriented format in a second file that is separate from the first BPMN process.

3. The computer-implemented method of claim 2, wherein the first file and the second file are the same file.

4. The computer-implemented method of claim 1, further comprising:
generating a third BPMN script that is the first BPMN script for a second BPMN process; and
storing the third BPMN script in a class oriented format in a third file that is separate from the second BPMN process.

5. The computer-implemented method of claim 4, wherein the first file and the third file are the same file.

6. The computer-implemented method of claim 2, further comprising:
generating a third BPMN script that is the first BPMN script for a second BPMN process; and
storing the third BPMN script in a class oriented format in a third file that is separate from the second BPMN process.

7. The computer-implemented method of claim 6, wherein the first file, the second file, and the third file are the same file.

8. The computer-implemented method of claim 1, further comprising mapping between a first BPMN artifact in the first BPMN process and a first object-oriented language artifact in the first file.

9. The computer-implemented method of claim 1, wherein the first BPMN script is generated using BPMN 2.0.

10. The computer-implemented method of claim 1, wherein the first file is a Groovy (.gy) file.

11. The computer-implemented method of claim 10, further comprising the Groovy file modeling as a class method at least one Script Activity in the first BPMN process.

12. The computer-implemented method of claim 1, further comprising comparing differences and merging conflicts in the first file.

13. The computer-implemented method of claim 1, further comprising retrieving incomplete and erroneous scripts in the first file.

14. The computer-implemented method of claim 13, further comprising determining the beginning and ending of each BPMN script in the first file.

15. One or more non-transitory, computer-readable media storing executable instructions that, when executed by a processor, cause the processor to perform the computer-implemented method of claim 1.

16. A system, comprising:
a processor operable to cause a first Business Process Modeling Notation (BPMN) script to be generated for a first BPMN process; and
a memory operable to store the first BPMN script in a class oriented format in a first file that is separate from the first BPMN process.

17. The system of claim 16, wherein the processor is further operable to cause a second BPMN script to be generated for the first BPMN process.

18. The system of claim 17, wherein the memory is further operable to store the second BPMN script in a second file that is separate from the first BPMN process.

19. The system of claim 18, wherein the first file is the second file.

20. The system of claim 16, wherein the processor is further operable to cause a third BPMN script to be generated for a second BPMN process.

21. The system of claim 20, wherein the memory is further operable to store the third BPMN script in a second file that is separate from the second BPMN process.
